(19) United States
(12) Patent Application Publication
(10) Pub. No.: US 2014/0215232 A1
(43) Pub. Date: Jul. 31, 2014

(54) USB ADAPTER

(71) Applicant: HON HAI PRECISION INDUSTRY CO., LTD., New Taipei (TW)

(72) Inventor: HSIEN-CHUAN LIANG, New Taipei (TW)

(73) Assignee: HON HAI PRECISION INDUSTRY CO., LTD., New Taipei (TW)

(21) Appl. No.: 13/896,339

(22) Filed: May 17, 2013

(30) Foreign Application Priority Data
Jan. 28, 2013 (TW) 102103103

(51) Int. Cl. G06F 1/26

(52) U.S. Cl. CPC G06F 1/266
USPC 713/310

(57) ABSTRACT

An exemplary USB adapter includes a power supply unit, a USB interface unit, a USB control chip, a line control chip, and a communication unit, and a single coaxial cable is utilized not only to supply working voltages to a USB device and a non-USB device, but also to interpret the data protocols between the two devices to enable communication between them.

### BACKGROUND

1. Technical Field

The present disclosure relates to USB adapters and, particularly, to a USB adapter used for data transmission.

2. Description of Related Art

A USB adapter converts mains electricity to a regulated voltage for a USB device, and cannot be used for data transmission. Adding data transmission function to a USB adaptor would be desirable in consolidating more functions into a single USB adaptor.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a USB adapter in accordance with an exemplary embodiment.

FIG. 2 is a block diagram of the USB adapter of FIG. 1.

FIG. 3 is a schematic view of a transmission cable of the USB adapter of FIG. 1.

### DETAILED DESCRIPTION

The embodiments of the present disclosure are described with reference to the drawings.

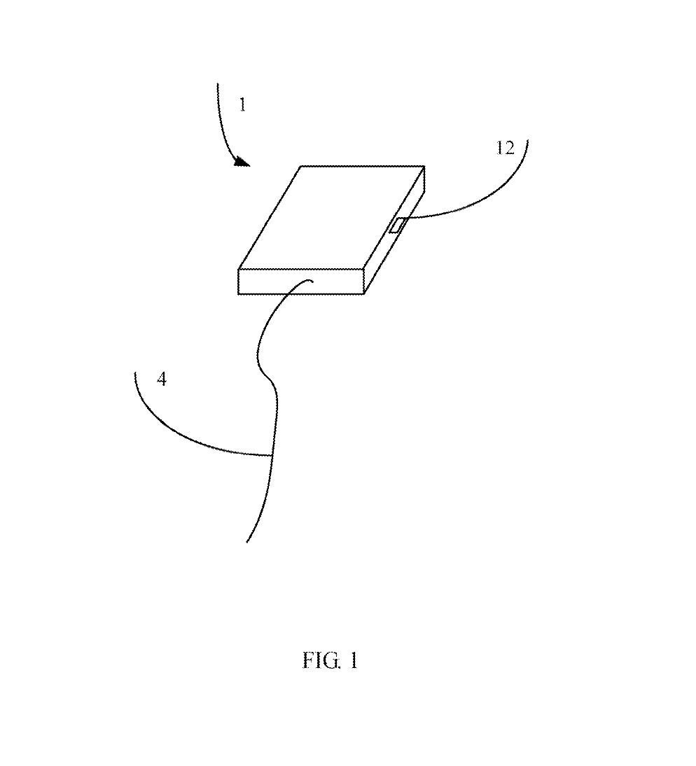

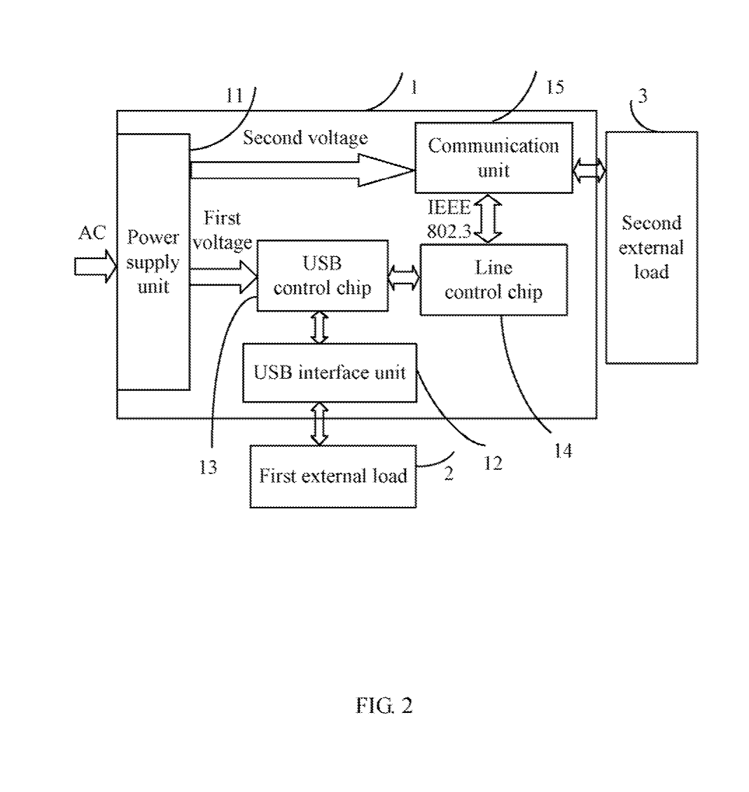

FIGS. 1-2 show a USB adapter 1 in accordance with an exemplary embodiment. The USB adapter 1 includes a power supply unit 11, a USB interface unit 12, a USB control chip 13, a line control chip 14, and a communication unit 15.

The power supply unit 11 receives mains electricity and converts the mains electricity to a first voltage supplied to the USB control chip 13 and a second voltage supplied to the communication unit 15. The first voltage, such as 5V, satisfies the power needs of a first external load 2. The second voltage, such as 13V, satisfies the power needs of a second external load 3. The first external load 2 may be a mouse or a keyboard. The second external load 3 may be a driver for other devices.

The USB interface unit 12 connects to the first external load 2.

The USB control chip 13 is connected to the USB interface unit 12. The USB control chip 13 identifies the first external load 2 connected to the USB interface unit 12, provides the first voltage to the first external load 2 via the USB interface unit 12, and receive USB-compatible data from the first external load 2 via the USB interface unit 12.

The line control chip 14 is connected between the USB control chip 13 and the communication unit 15. The line control chip 14 receives the USB-compatible data from the USB control chip 13, converts the data received from the USB control chip 13 to IEEE802.3 data, and outputs the converted IEEE802.3 data to the communication unit 15.

The communication unit 15 is connected to the line control chip 14 and communicates with the second external load 3. The communication unit 15 provides the second voltage and the converted IEEE802.3 data to the second external load 3. In the embodiment, the communication unit 15 communicates with the second external load 3 via a transmission cable 4.

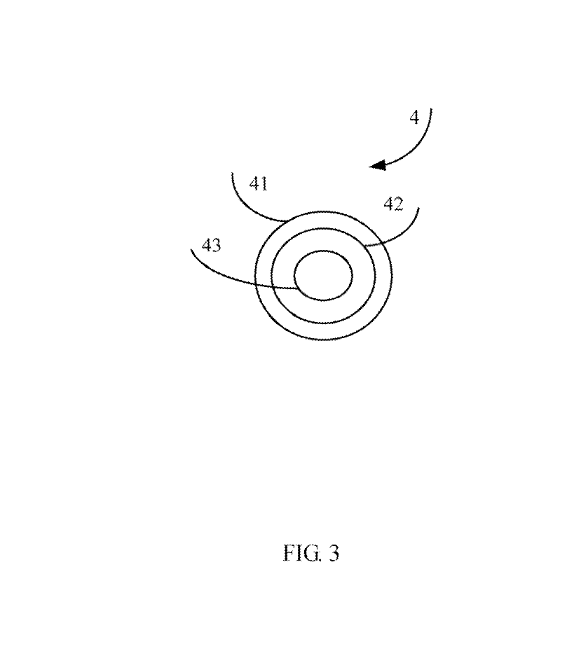

FIG. 3 shows a schematic view of the transmission cable 4 in accordance with an exemplary embodiment. The USB adapter 1 further includes the transmission cable 4. The transmission cable 4 includes a ground wire 41, a power wire 42, and a coaxial cable 43. The ground wire 41 and the power wire 43 cooperatively transmit the second voltage converted by the power supply unit 11 to the second external load 3. The coaxial cable 42 transmits the IEEE802.3 data from the communication unit 15 to the second external load 3.

In the embodiment, the line control chip 14 further receives IEEE802.3 data from the second external load 3, converts the received IEEE802.3 data to USB-compatible data, and outputs the converted data to the USB control chip 13. The USB control chip 13 further provides the converted data to the first external load 2 via the USB interface unit 12. Thus, data can be exchanged between the first external load 2 and the second external load 3, in other words, data from the first external load 2 can be transmitted to the second external load 3 and data from the second external load 3 can be transmitted to the first external load 2.

With this structure, the data is carried in only one cable without the power losses that occur in other types of the transmission lines, thus the data transmission distance between the first external load 2 and the second external load 3 is increased. Moreover, the coaxial cable 4 contains the characteristics of high bandwidth, thus the data speed transmission between the first external load 2 and the second external load 3 is increased.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. A USB adapter comprising:
a USB interface unit configured to connect to a first external load;
a USB control chip connected to the USB interface unit, the USB control chip being configured to identify the first external load connected thereto via the USB interface unit and receive USB-compatible data from the first external load via the USB interface unit;
a line control chip connected to the USB control chip, the line control chip being configured to receive USB-compatible data from the USB control chip and convert the received USB-compatible data to IEEE802.3 data;
a communication unit connected to the line control chip and configured to communicate with a second external load; and
a power supply unit configured to receive mains electricity and convert the received mains electricity to a first voltage supplied to the USB control chip and a second voltage supplied to the communication unit;
wherein the communication unit is further configured to provide the second voltage and the IEEE802.3 data converted by the line control chip to the second external load; the USB control chip is further configured to provide the first voltage to the first external load via the USB interface unit.

2. The USB adapter as described in claim 1, further comprising a transmission cable configured to connect the second external load to the communication unit, the transmission cable comprising a ground wire, a power wire, and a coaxial cable;
wherein the ground wire and the power wire cooperatively transmit the second voltage converted by the power supply unit to the second external load; the coaxial cable transmits the IEEE802.3 data between the communication unit and the second external load.

3. The USB adapter as described in claim 1, wherein the line control chip is further configured to receive IEEE802.3 data from the second external load, convert the received IEEE802.3 data to the USB-compatible data, and output the converted USB-compatible data to the USB control chip; the USB control chip is further configured to provide the converted USB-compatible data to the first external load via the USB interface unit.
